(19) United States
(12) Patent Application Publication
(10) Pub. No.: US 2006/0255747 A1
(43) Pub. Date: Nov. 16, 2006

(54) Lighting apparatus for discharge lamp

(76) Inventors: Tomoyuki Ichikawa, Shizuoka (JP); Takao Muramatsu, Shizuoka (JP)

Correspondence Address: FISH & RICHARDSON P.C., P.O. BOX 1022, MINNEAPOLIS, MN, 55440-1022, US

(21) Appl. No.: 11/435,432

(22) Filed: May 16, 2006

(30) Foreign Application Priority Data
May 16, 2005 (JP) P.2005-142338

(51) Int. Cl. H05B 39/04

(52) U.S. Cl. 315/209 R

(57) ABSTRACT

A A lighting apparatus for a discharge lamp includes a transformer for electric power transmission to the discharge lamp and for supplying a start signal to the discharge lamp. The transformer includes closed magnetic circuit type cores (15, 16) formed of magnetic material, a primary winding 7p, a secondary winding 7s, and an auxiliary winding 7v provided for supplying a voltage necessary for generating the start signal to the start circuit. The primary winding 7p and the secondary winding 7s are wound around the periphery of a common core pole 15a, and the auxiliary winding 7v is wound around another core pole 15b. The start signal is generated based on a voltage supplied from the auxiliary winding 7v and applied to the discharge lamp via the main windings (7p, 7s).

### TECHNICAL FIELD

The present disclosure relates to a lighting apparatus for a discharge lamp.

### BACKGROUND

A known configuration for a lighting circuit for a discharge lamp, such as a metal halide lamp used for an illumination light source for a vehicle, includes a DC boosting circuit having a DC-DC converter, a DC/AC conversion circuit and a start circuit. For example, this configuration is arranged so that a DC input voltage from a battery is converted into a desired voltage by the DC boosting circuit, and the desired voltage is converted into an AC output by the DC/AC conversion circuit of the succeeding stage. A start signal is superimposed on the AC output and supplied to the discharge lamp (see, e.g., Japanese patent document JP-UM-A-6-13100). A switching regulator with a transformer, for example, can be used as the DC boosting circuit. A dedicated transformer can be used as a circuit for generating the start signal.

The known lighting circuit requires a transformer for transmitting electric power to a discharge lamp and a transformer for generating a start pulse, so that the size and cost of the apparatus are increased. For example, in the case of using a discharge lamp as an illumination light source for a vehicle, the light circuit is required to be disposed within a limited space (for example, in a housing for a lighting circuit unit within a lamp).

Accordingly, it would be desirable to reduce the size of a lighting apparatus for a discharge lamp and to reduce the number of parts and the cost of the apparatus.

### SUMMARY

The disclosure relates to a configuration in a lighting apparatus for a discharge lamp. The configuration includes a transformer having both an electric power transmission function for a discharge lamp and a start function for supplying a start signal to the discharge lamp. The configuration also includes a DC/AC conversion circuit which receives a DC input voltage to perform an AC conversion and supply an output of the transformer to the discharge lamp, and a start circuit which applies the start signal to the discharge lamp.

The transformer includes a closed magnetic circuit type core formed of magnetic material, a main winding having a primary winding and a secondary winding, and an auxiliary winding for supplying a voltage for generating the start signal to the start circuit.

The primary winding and the secondary winding are wound around the periphery of a common core pole, and the auxiliary winding is wound around another core pole that is separate from the common core pole around which the primary winding and the secondary winding are wound.

The start circuit generates the start signal based on a voltage supplied from the auxiliary winding and applies the start signal to the discharge lamp via the main winding.

Thus, as a single transformer is employed to perform the power transmission to the discharge lamp and to apply the start signal to the discharge lamp, it can simplify the circuit configuration and facilitate its reduction in size. Further, as the primary winding and the secondary winding constituting the main winding are wound around the common core pole, the magnetic coupling between them can be enhanced. Furthermore, as the auxiliary winding is wound around another core pole which is separate from the common core pole, the magnetic coupling between the auxiliary winding and the main winding can be weakened.

In some implementations, the disclosed configuration can help reduce the size of the discharge lamp lighting apparatus and can contribute to the reduction of the number of parts and the cost. For example, in the case of using the discharge lamp as a light source for an automobile, the configuration can be effective when applied to the lighting apparatus of a resonance type high-frequency lighting method (the supply voltage to the start circuit can be obtained without using a converter transformer in the primary side circuit of the transformer). As the magnetic coupling between the auxiliary winding and the main winding is weakened, the influence of a high voltage induced at the auxiliary winding upon generation of the start signal can be reduced. Further, the core loss can be reduced compared with the configuration in which the auxiliary winding is added to the resonance coil.

As the transformer structure for weakening the magnetic coupling between the auxiliary winding and the main winding, it is preferable, in a closed magnetic circuit type structure using an E-shaped core or a U-shaped core, to wind the main winding around the linear portion of the first core pole and to wind the auxiliary winding around the linear portion of the second core pole.

Other features and advantages may be apparent from the following detailed description, the accompanying drawings, and the claims.

### BRIEF DESCRIPTION OF THE DRAWINGS

FIG. 1 is a diagram showing an example of a circuit configuration according to the invention.

FIG. 2 is a diagram showing an example of the structure of a transformer together with FIG. 3.

FIG. 3 is an exploded perspective view.

FIG. 4 is a diagram showing the wirings within the transformer.

FIG. 5 shows an example of the configuration of a primary winding.

FIG. 6 is a diagram showing an example of the circuit configuration of a main portion relating to the generation of a start signal.

### DETAILED DESCRIPTION

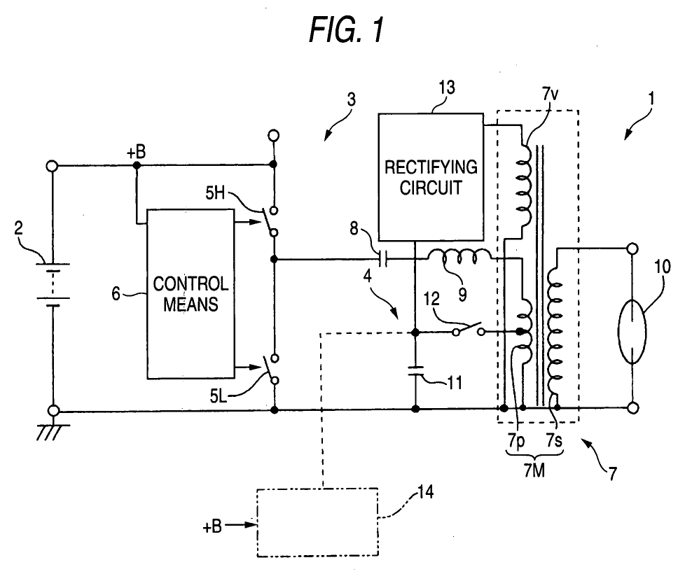

FIG. 1 is a diagram showing an example of a configuration of a lighting apparatus for a discharge lamp according to the invention, in which the discharge lamp lighting circuit 1 includes a DC/AC conversion circuit 3 for receiving power from a DC power source 2 and a start circuit 4.

The DC/AC conversion circuit 3 is provided to receive a DC input voltage (see +B in the figure) from the DC power source 2 and to perform the AC conversion and the boosting. In this embodiment, the DC/AC conversion circuit includes two switching elements 5H, 5L and a controller (control means 6) for performing the driving control of these switching elements. That is, the one end of the switching element 5H on the high voltage side is coupled to the terminal of the power source, and the other end of this switching element is grounded via the switching element 5L on the low voltage side. The control means 6 alternatively turns on and off the two switching elements 5H, 5L. Although each of the switching elements 5H, 5L is represented by a symbol of a switch for the sake of the simplification, a semiconductor element such as a field effect transistor (FET) or a bipolar transistor can be used as each of these switching elements.

The DC/AC conversion circuit 3 includes a series resonance circuit having an inductance element or a transformer and a capacitor. In this embodiment, the DC/AC conversion circuit 3 has a transformer 7 for power transmission. The transformer employs, on its primary side, a circuit configuration utilizing the resonance phenomenon caused by a resonance capacitor 8 and an inductor or inductance component. Such a configuration can operate in the following three modes, for example.

(I) A first mode utilizing the resonance caused by the resonance capacitor 8 and an inductance element.

(II) A second mode utilizing the resonance caused by the resonance capacitor 8 and the leakage inductance of the transformer 7.

(III) A third mode utilizing the resonance caused by the resonance capacitor 8, the inductance element and the leakage inductance of the transformer 7.

In the first mode (I), an inductance element 9 such as a resonance coil is provided. One end of the inductance element is coupled to the resonance capacitor 8, and the resonance capacitor 8 is coupled to a coupling point between the switching elements 5H and 5L. The other end of the inductance element 9 is coupled to the primary winding 7p of the transformer 7.

In the second mode (II), it is not necessary to add a resonance coil by utilizing the inductance component of the transformer 7. That is, one end of the resonance capacitor 8 is coupled to the coupling point between the switching elements 5H and 5L, and the other end of the resonance capacitor 8 is coupled to the primary winding 7p of the transformer 7.

In the third mode (III), a series composite reactance of the inductance element 9 and the leakage inductance can be used.

In each of the foregoing modes, the driving frequency of the switching elements 5H. 5L is defined to be equal to or larger than the series resonance frequency by utilizing the series resonance of the resonance capacitor 8 and the inductive element (the inductance component or the inductance element), and the switching elements are alternately turned on and off to light the discharge lamp 10 (e.g., a metal halide lamp used for a vehicle lamp) coupled to the secondary winding 7s of the transformer 7 in a sine wave manner. During driving control of the respective switching elements by the control means 6, it is necessary to drive the respective elements in an opposite manner so that the two switching elements are not placed simultaneously in an on-state (depending, for example, on the on-duty control). As to the series resonance frequency, assuming that the resonance frequency before the lighting is “f1,” the resonance frequency in the lighting state is “f2,” the electrostatic capacitance of the resonance capacitor 8 is “Cr,” then the inductance of the inductance element 9 is “Lr” and the primary side inductance of the transformer 7 is “Lp1”, f1=1/(2·π·√(Cr(Lr+Lp1)) in the state before the lighting of the discharge lamp in the third mode (III), for example. If the driving frequency is lower than f1, the loss of the switching elements becomes large and so the efficiency is degraded. Thus, the switching operation is performed at the frequency range higher than f1. Further, after the lighting of the discharge lamp, f2 becomes almost equal to 1/(2·π·√(Cr·Lr)), where f1<f2. In this case, the switching operation is performed at the frequency range higher than f2.

The transformer 7 includes a main winding 7M having a primary winding 7p and a secondary winding 7s and further includes an auxiliary winding 7v provided for generating a start signal for the discharge lamp 10.

The start circuit 4 is provided to supply a start signal to the discharge lamp 10. The start circuit includes, in the illustrated example, a capacitor 11, an element 12 (which is represented by a symbol of a switch in the figure for the sake of the simplification) and a rectifying circuit 13. The voltage obtained by the auxiliary winding 7v is supplied to the capacitor 11 via the rectifying circuit 13, and the element 12 becomes conductive when the terminal voltage of the capacitor 11 exceeds a predetermined threshold value. A signal generated at the primary winding 7p of the transformer 7 at this time is boosted by the transformer 7 and applied to the discharge lamp 10 (the start signal is superimposed on the AC-converted output and supplied to the discharge lamp 10). In this example, one end of the self-yield type element 12 is coupled to an intermediate tap of the primary winding 7p.

In the configuration of FIG. 1, the transformer has a function of transmitting electric power to the discharge lamp 10 and also a start function for supplying the start signal to the discharge lamp 10. That is, the DC/AC conversion circuit 3 performs conversion of the DC input to AC and boosting of the AC to control the power to the discharge lamp 10 under the control of the control means 6. Further, the start circuit 4 generates the start signal based on the voltage supplied from the auxiliary winding 7v of the transformer 7 and supplies the start signal to the discharge lamp via the main winding 7M of the transformer 7.

A circuit configuration can include a primary voltage generation circuit 14, as shown by a broken line and a two-dot chain line in FIG. 1, for example, without providing the auxiliary winding 7v with respect to the capacitor 11. According to this circuit configuration, a flyback-type DC-DC converter receives the DC input voltage “+B” and, thus, can obtain a desired voltage. However, the capacitor 11 is started to be charged after the DC-DC converter starts the boosting, and so the discharge time of the secondary current of the transformer (converter transformer) constituting the converter becomes shorter as the voltage of the capacitor 11 increases. A problem may occur that sufficient boosting cannot be achieved. That is, the discharge time of the secondary current is inversely proportional to the output voltage of the converter, and so the discharge time becomes shorter according to the increase of the voltage. As a result, according to the influence of the junction capacitance of the rectifying diode within the converter, energy originally removed from the secondary side cannot be obtained and, thus, the boosting cannot be performed sufficiently. Alternatively, to the inductance of the converter transformer can be increased so that the size of the transformer becomes large, which effects the switching elements, the control circuit, and a diode, and also results in increased cost.

As a further example, the primary voltage necessary for starting the discharge lamp can be obtained using the inductance element 9 (resonance coil) and the secondary winding 7s. In such a configuration, an auxiliary winding is added to the resonance coil. As the size of the core becomes large, a thermal problem may arise as a result of the increase of loss (that is, the core loss is proportional to the volume of the core). According to an alternative technique of using the secondary winding of the transformer, the start signal formed as a high-voltage pulse is generated, and the start signal is applied to the capacitor 11. In that case, a problem may arise because the pulse is attenuated.

Thus, the present technique employs a configuration in which the auxiliary winding 7v is provided at the transformer 7 to obtain the voltage necessary for generating the start signal and to supply the voltage to the capacitor 11 from the rectifying circuit 13 of the start circuit 4. The various problems described above can be avoided. In addition, a compact size can be achieved. For example, the converter transformer can be eliminated in the primary voltage generation circuit within the start circuit 4 and, thus, it is suitable for simplifying the circuit configuration.

Next, an example of the configuration of the transformer is described.

In some implementations, the transformer has the configuration of a closed magnetic circuit type using an E-shaped core or a U-shaped core and can be configured in the following modes listed below.

Modes:

A configuration combining two E-shaped cores.

A configuration combining an E-shaped core and an I-shaped core.

A configuration combining two U-shaped cores.

A configuration combining a U-shaped core and I-shaped core.

The transformer is configured such that a magnetic circuit is closed by a round portion of the core of the magnetic material and the gap. Such an open-type configuration including only the I-shaped cores is excluded.

The core of the magnetic material is configured so that the main winding 7M is wound around the linear portion of a first core pole and the auxiliary winding 7v is wound around the linear portion of a second core pole.

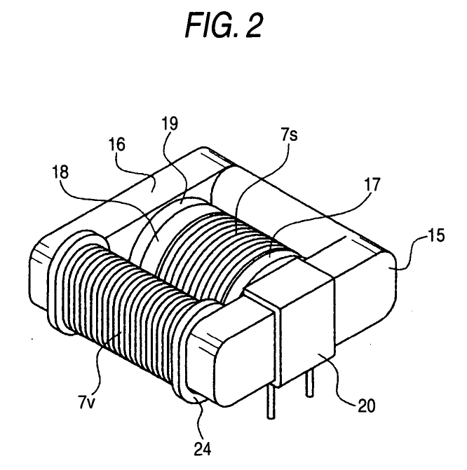

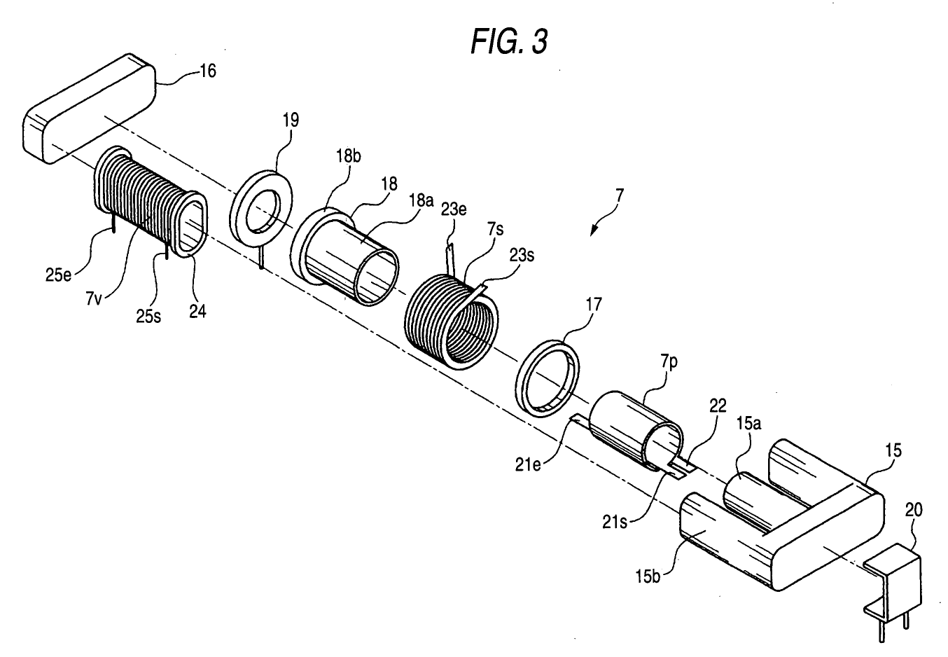

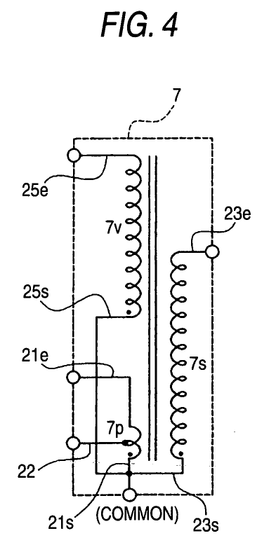

FIGS. 2 to 4 shows an example of the transformer 7 that includes an E-shaped core and I-shaped core. FIG. 2 is a perspective view, and FIG. 3 is an exploded perspective view. FIG. 4 is a wiring diagram within the transformer.

In FIG. 3, the primary winding 7p, a spacer 17, the secondary winding 7s, an insulation bobbin 18, and a terminal table 19 that also serves as a spacer, are disposed between the E-shaped core and the I-shaped core 16 along the center axis of the first core pole 15a, which is the center leg of the E-shaped core 15. A terminal table 20 is attached to the E-shaped core 15.

In this example, the primary winding 7p is disposed around the outer periphery of the first core pole 15a, the insulation bobbin 18 is disposed around the primary winding, and the secondary winding 7s is wound around the outer periphery of the insulation bobbin 18. In the magnetic circuit using the E-shaped core 15 and the I-shaped core 16, a gap is formed between the first core pole 15a and the I-shaped core 16.

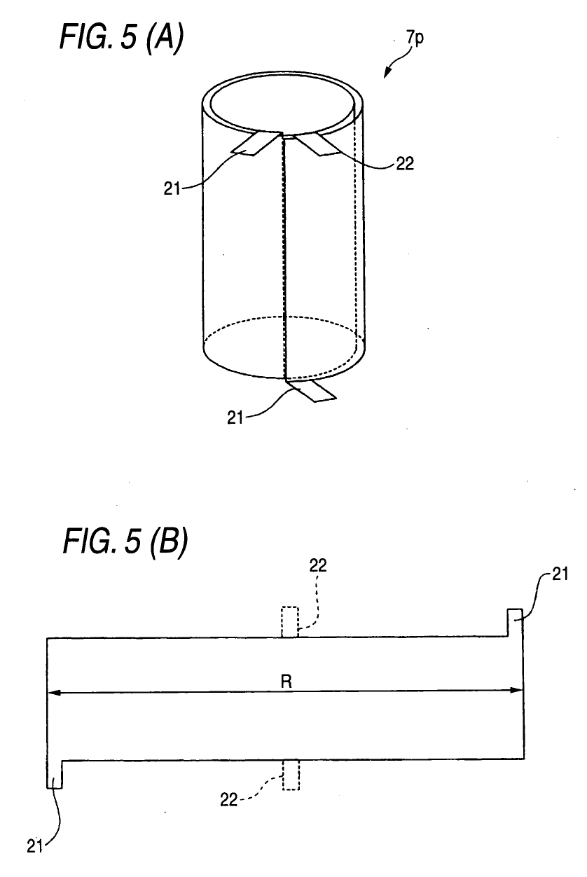

As shown in FIGS. 3 and 5, the primary winding 7p is formed in a roll shape by using a thin conductive material and has a structure that it is wound in a spiral shape when seen from the direction along its center axis. For example, as shown in FIG. 5(B), the primary winding 7p has a pair of terminals 21, 21. These terminals are respectively formed at the diagonal positions on the opposite sides with respect to the winding direction of the primary winding 7p (a direction indicated by an arrow R in the figure). Thus, the primary current flows uniformly at the conductive portion of the primary winding 7p, so that it is possible to avoid unevenness in the coupling state between the primary winding and the secondary winding 7s.

The primary winding 7p has a coupling end 22 to be coupled to the start circuit 4. For example, as shown by the broken line in FIG. 5(B), the coupling end 22 is integrally formed at one of the long sides extending to the winding direction of the primary winding. FIG. 3 shows the winding start point 21s, the winding end point 21e and the coupling end 22 of the primary winding, wherein the winding start point 21s and the coupling end 22 are formed in the same direction and the winding end point 21e is formed in the opposite direction.

A thin plate made of metal or a flexible conductor of a film-shape (such as a flexible printed wiring plate) may be used, for example, as the base material of the primary winding 7p.

The secondary winding 7s is formed in a coil shape by using a conductive wire rod, for example. The base material of the secondary winding 7s can be arranged to have a configuration with a so-called edgewise winding in which a rectangular wire is wound and piled up in an annular shape. In that case, the transformer can be configured with the minimum size while suppressing copper loss.

The ends of the winging 7s serves as a winding start point 23s and a winding end point 23e, respectively.

The insulation bobbin 18 can be configured by integrally forming a cylindrical portion 18a and a flange portion 18b. The primary winding 7p is disposed within the hole of the cylindrical portion 18a.

In the illustrated implementation, each of the spacer 17 and the terminal table 19 is formed in a ring shape. The terminal table 19 has a terminal portion to which the portion 21e of the primary winding 7p is coupled. That is, the portion 21e of the primary winding 7p is coupled to an external circuit (not shown) via the terminal table 19.

The main winding 7M can enhance the magnetic coupling between the primary winding 7p and the secondary winding 7s. The primary winding 7p and the secondary winding 7s are wound around the periphery of the common pole (the center leg portion 15a in this example) which serves as the center axis. In other words, this example shows a configuration in which the primary winding is disposed around the outer periphery of the core pole, and the secondary winding is further disposed around the primary winding. However, the invention is not limited to this configuration and may employ an arrangement in which the positional relationship between the primary winding and the secondary winding is reversed (i.e., the secondary winding is disposed around the outer periphery of the core pole, and the primary winding is disposed around the secondary winding).

In FIG. 3, the auxiliary winding 7v is wound around a bobbin 24 by using a conductive wire rod. The ends of the auxiliary winding are formed as portions 25s and 25e, respectively.

The auxiliary winding 7v is disposed on the outer periphery of another core pole 15b (an outer leg in this example) which is provided separately from the first core pole 15a around which the main winding 7M is wound. This arrangement allows weakening of the magnetic coupling between the main winding 7M and the auxiliary winding. If the auxiliary winding 7v is disposed so that the magnetic coupling is almost the same as that of the main winding, a high-voltage pulse having almost the same level as the start signal (generated when the discharge lamp is started) is inducted at the auxiliary winding 7v. The induced signal is absorbed by the capacitor 11 so that energy necessary for generating the start signal cannot be utilized effectively. Such a problem can be prevented by weakening the magnetic coupling between the main winding 7M and the auxiliary winding 7v.

The U-shaped terminal table 20 can have a terminal portion to which the coupling end 22 of the primary winding 7p is coupled and terminal portions to which the winding start portions of the respective windings are coupled. These terminal portions are coupled to the external circuit via the terminal table 20.

As shown in FIG. 4, the portion 25s of the auxiliary winding 7v, the portion 21s of the primary winding 7p and the portion 23s of the secondary winding 7s provided at the transformer are coupled to each other and coupled to the common terminal (“COMMON”).

The symbol “·” in the figure represents the winding start point. When the polarities are adjusted or made to coincide between the voltage generated by the secondary winding 7s and the voltage generated by the auxiliary winding 7v according to the polarities shown in the figure, the voltage difference within the transformer can be suppressed. (That may be attributed to the simplification of the voltage withstand structure.) For example, supposing that the voltage induced at the auxiliary winding when the start signal is generated is 5 kV, and the peak value of the secondary voltage as a result of the start signal is 25 kV, the transformer only needs to have the insulation withstand voltage corresponding to the voltage difference of 20 kV according to the aforesaid polarity coincidence. In contrast, when the polarities are set in the opposite manner from the aforesaid case, an insulation withstand voltage of 25 kV is required, which requires a larger transformer structure.

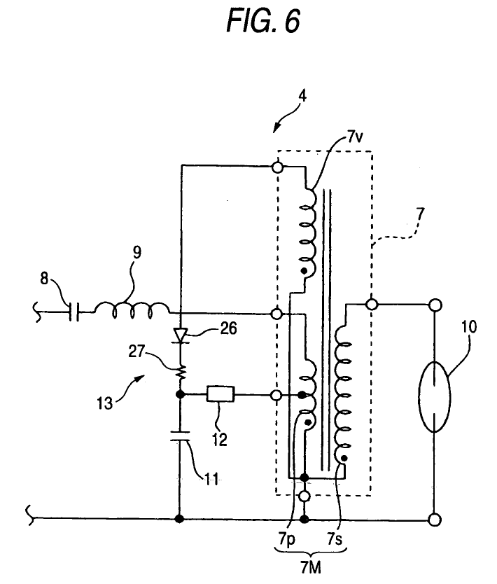

FIG. 6 shows an example of the circuit configuration using the foregoing transformer, in which the start circuit 4 generates the start signal based on the voltage obtained by the auxiliary winding 7v, and the start signal is applied to the discharge lamp 10 via the main winding 7M of the transformer 7.

The start circuit 4 includes the capacitor 11, the element 12 and the rectifying circuit 13.

In this example, one end of the capacitor 11 is coupled to the coupling terminal (22) of the primary winding 7p via the self-yield type element 12 such as a spark gap. The other end of the capacitor 11 is grounded and also coupled to the common terminal of the transformer 7.

The rectifying circuit 13 uses a diode 26 and a resistor 27. The diode 26 is coupled at its anode to one end (i.e., winding end point) of the auxiliary winding 7v and also coupled at its cathode to the coupling point between the capacitor 1 and the element 12 via the resistor 27.

The capacitor 11 is charged from the auxiliary winding 7v via the diode 26. The element 12 becomes conductive when the terminal voltage of the capacitor 11 exceeds the threshold value, and then the high-voltage pulse is generated. In other words, the voltage obtained from the auxiliary winding 7v is applied to the capacitor 11 via the diode 26 and the resistor 27, the terminal voltage of the capacitor increases, and when the element 12 becomes conductive, the signal generated at the primary winding 7p of the transformer 7 is boosted by the transformer and applied to the discharge lamp 10 as the start signal.

This embodiment can help simplify the circuit arrangement and reduce costs.

In the case of detecting the current flowing into the discharge lamp and the voltage applied to the discharge lamp in the power control of the discharge lamp, the detection can be realized by providing one of several kinds of configurations including, for example, a detection terminal at the secondary winding or the addition of a detecting winding on the secondary side of the transformer.

Other implementations are within the scope of the claims.

What is claimed:

1. A lighting apparatus for a discharge lamp comprising:
a transformer for electric power transmission to the discharge lamp and for supplying a start signal to the discharge lamp,
a DC/AC conversion circuit to receive a DC input voltage to perform AC conversion and to supply an output of the transformer to the discharge lamp, and
a start circuit to apply the start signal to the discharge lamp,
wherein the transformer includes a closed magnetic circuit type core formed of magnetic material, a main winding having a primary winding and a secondary winding, and an auxiliary winding to supply a voltage to generate the start signal to the start circuit,
wherein the primary winding and the secondary winding are wound around a periphery of a common core pole, and the auxiliary winding is wound around another core pole which is separate from the common core pole, and
wherein the start circuit is adapted to generate the start signal based on a voltage supplied from the auxiliary winding and to apply the start signal to the discharge lamp via the main winding.

2. A lighting apparatus for a discharge lamp according to claim 1, wherein the transformer comprises an E-shaped core or a U-shaped core having a fist core pole and a second core pole, wherein the main winding is wound around a linear portion of the first core pole, and the auxiliary winding is wound around a linear portion of the second core pole.
